(19) United States
(12) Patent Application Publication
(10) Pub. No.: US 2015/0263444 A1
(43) Pub. Date: Sep. 17, 2015

(54) CONNECTOR AND PIN OF CONNECTOR

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIAO WANG, Wuhan (CN); YUN-FEI HE, Wuhan (CN); YU-LIN LIU, Wuhan (CN)

(21) Appl. No.: 14/540,560

(22) Filed: Nov. 13, 2014

(30) Foreign Application Priority Data
Mar. 14, 2014 (CN) 201410094061.9

(51) Int. Cl. H01R 13/04; H01R 13/42

(52) U.S. Cl. CPC H01R 13/04; H01R 13/42

(57) ABSTRACT

A connector includes a base and plurality of pins latched to the base. The base has a bottom plate configured to support an electronic component. Each pin has a basic member and a latch member. The basic member is configured to connect to the electronic component, and the latch member is configured to latch to a circuit board. The basic member is removable and coupled to the latch member, and the bottom plate is sandwiched between the basic member and the latch member. This disclosure further discloses a pin using in the connector.

### FIELD

The subject matter herein generally relates to connectors for electronic devices, and relates to pins of the connectors.

### BACKGROUND

A variety of electronic components, such as expansion cards, can be connected to electronic devices by connectors. A number of pins can be latched to the connectors for connecting the electronic components. However, there is room for improvement in the art.

### BRIEF DESCRIPTION OF THE DRAWINGS

Implementations of the present technology will now be described, by way of example only, with reference to the attached figures.

FIG. 1 is an exploded, isometric view of an embodiment of a connector which includes at least one pin.

FIG. 2 is an exploded, isometric view of a pin from FIG. 1.

FIG. 3 is an assembled, isometric view of the connector of FIG. 1.

FIG. 4 is a cross-sectional view of a connector taken along line IV-IV of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a connector having a plurality of pins. The connector includes a base and a plurality of pins latched to the base. The base has a bottom plate configured to support an electronic component. Each pin has a basic member and a latch member. The basic member is configured to connect to the electronic component, and the latch member is configured to latch to a circuit board. The basic member is removable and coupled to the latch member, and the bottom plate is sandwiched between the basic member and the latch member.

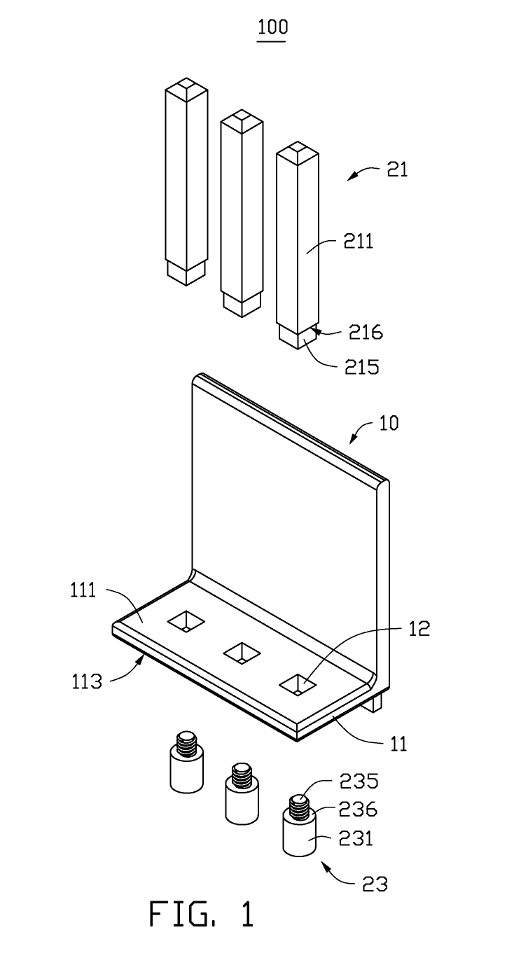

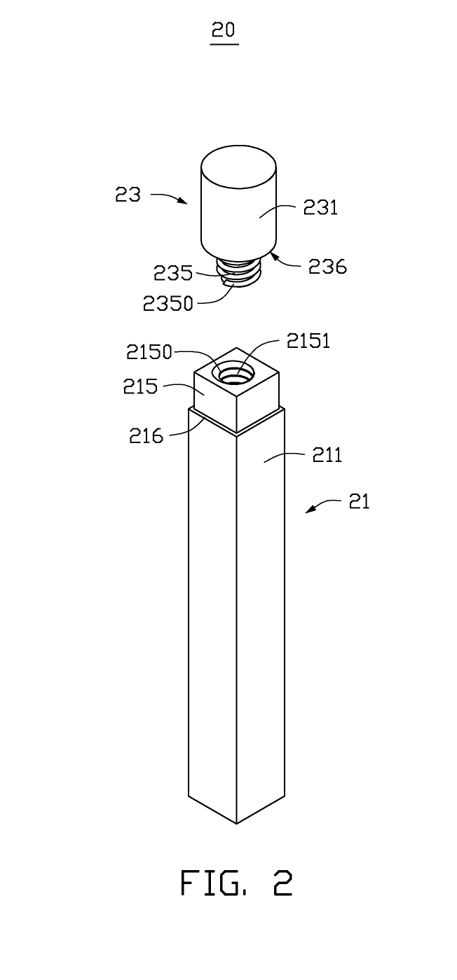

FIG. 1 illustrates that a connector 100 includes a base 10 and a plurality of pins 20 (shown in FIG. 2). The base 10 has a bottom plate 11 configured to support at least one electronic component (not shown). Each pin 20 is coupled to the bottom plate 11 and configured to connect to the electronic component to a circuit board (not shown). In at least one embodiment, the connector 100 includes three pins 20. A latch hole 12 is defined in the bottom plate 11 corresponding to each pin 20.

FIG. 2 illustrates that each pin 20 includes a basic member 21 and a latch member 23. The basic member 21 is configured for connecting to the electronic component. The latch member 23 is configured for connecting to the circuit board. The basic member 21 is removable and coupled to the latch member 23. The basic member 21 includes a connecting portion 211 and a linking portion 215 extending from the connecting portion 211. The connecting portion 211 is configured to connect to the electronic component. A width of the connecting portion 211 is greater than a width of the linking portion 215, thereby a first step surface 216 is formed in a joint of connecting portion 211 and the linking portion 215. The first step surface 216 is configured to resist a plane surface of an object abutted by the basic member 21.

Each linking portion 215 is configured to engage with each latch hole 12 (shown in FIG. 1). In at least one embodiment, a width of each linking portion 215 is not less than a width of each latch hole 12. In another embodiment, the width of each linking portion 215 is substantially equal to the width of each latch hole 12. In another embodiment, the linking portion 215 and the latch hole 12 is interference fit. In at least one embodiment, the linking portion 215 is cubic.

The latch member 23 includes a securing portion 231 and a coupling portion 235 extending from the securing portion 231. The securing portion 231 is configured to connect to the circuit board. The coupling portion 235 is configured for coupling to the linking portion 235. A width of the securing portion 231 is greater than a width of the coupling portion 235; thereby a second step surface 236 is formed in a joint of the securing portion 231 and the coupling portion 235. The second step surface 236 is configured to resist a plane surface of an object abutted by the latch member 23.

A securing hole 2151 is defined in a bottom of the linking portion 215 for receiving the coupling portion 235. In at least one embodiment, an internal thread 2150 is formed from an inner surface of the securing hole 2151, and an external thread 2350 is formed from an as outer surface of the coupling portion 235.

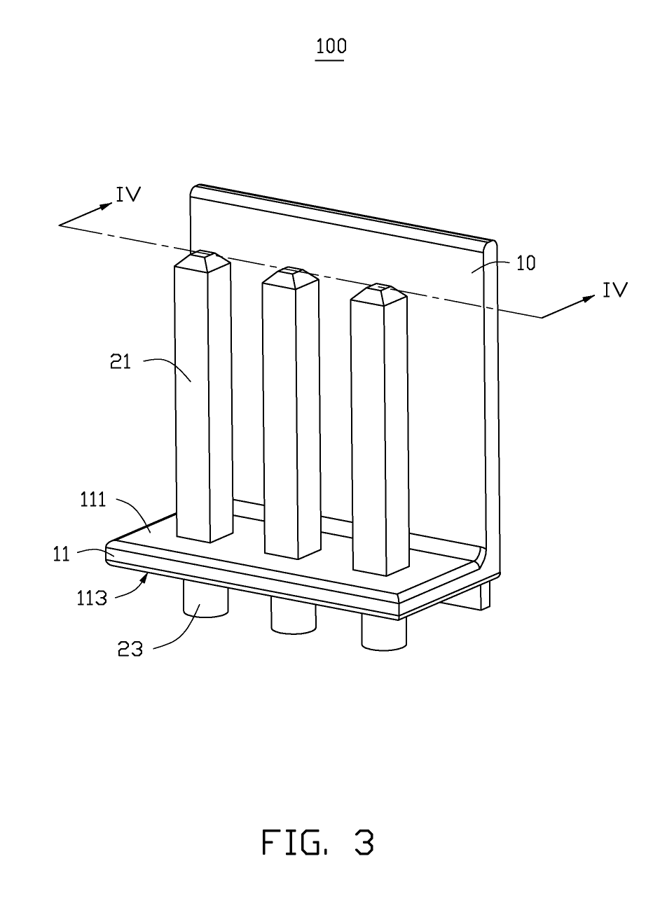

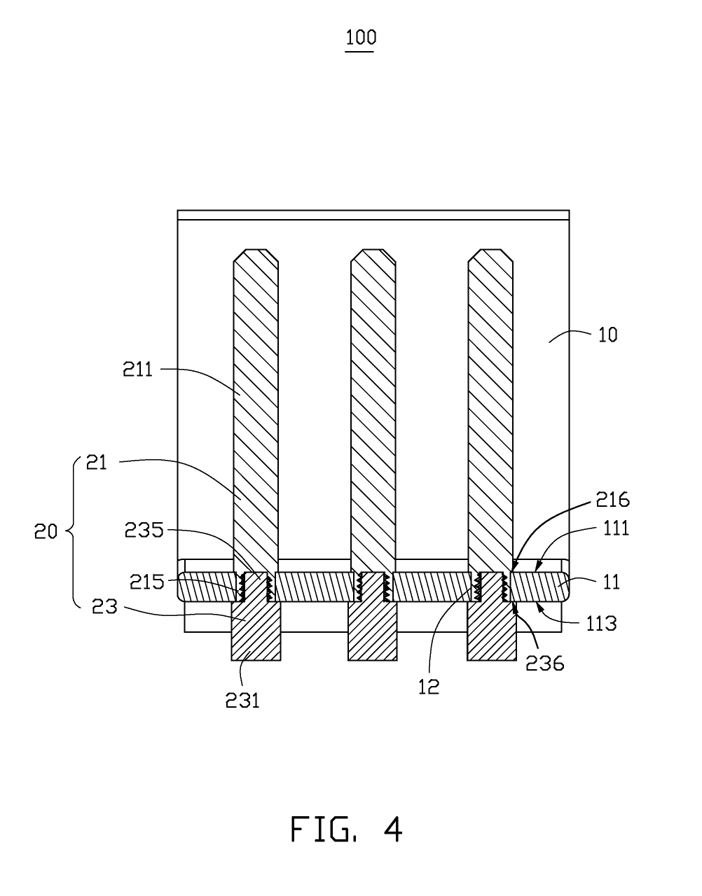

FIGS. 3-4 illustrate when in assembly, each basic member 21 and each latch member 23 are located at opposite sides of the bottom plate 11. Each linking portion 215 is engaged with each latch hole 12, and each coupling portion 235 is received in each securing hole 2151 for coupling to each linking portion 215. When each basic member 21 is coupled to the latch member 23, the bottom plate 11 is sandwiched between the basic member 21 and the latch member 23. The first step surface 216 resists a top surface 111 of the bottom plate 11, and the second step surface 236 resists a bottom surface 113 of the bottom plate 11. Each pin 20 is coupled to the bottom plate 11 and extends from opposite sides of the bottom plate 11.

In use, the securing member 23 is connected to the circuit board by normal methods such as welding; thereby each pin 20 is firmly latched to the circuit board. The bottom plate 11 is sandwiched between the basic member 21 and the securing member 23, and the opposite surfaces of the bottom plate 11 are resisted by the first step surface 216 and the second step surface 236. The base 10 sandwiched by the pins 20 is latched to the circuit board firmly.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A pin comprising:
a basic member configured to connect to an electronic component; and
a latch member configured to connect to a circuit board;
wherein the basic member is removably coupled to the latch member.

2. The pin of claim 1, wherein the basic member comprises a linking portion, and the latch member comprises a coupling portion for coupling to the linking portion.

3. The pin of claim 2, wherein a securing hole is defined in the linking portion, and the coupling portion is received in the securing hole.

4. The pin of claim 3, wherein an external thread is formed from the coupling portion, and an internal thread is formed from the securing hole.

5. The pin of claim 2, wherein the basic member further comprises a connecting portion, and a width of the connecting portion is greater than a width of the linking portion.

6. The pin of claim 5, wherein the connecting portion is connected to the linking portion to form a first step surface, and the first step surface is configured to resist a plane surface of an object.

7. The pin of claim 2, wherein the latch member further comprises a securing portion, and a width of the securing portion is greater than a width of the coupling portion.

8. The pin of claim 7, wherein the securing portion is connected to the coupling portion to form a second step surface, and the second step surface is configured to resist a plane surface of an object.

9. The pin of claim 2, wherein the linking portion is cubic.

10. A connector comprising:
a base having a bottom plate configured to support an electronic component; and
a pin coupled to the bottom plate, having a basic member configured to connect to the electronic component and a latch member configured to connect to a circuit board;
wherein the basic member is removably coupled to the latch member, and the bottom plate is sandwiched between the basic member and the latch member.

11. The connector of claim 10, wherein a latch hole is defined in the bottom plate, and the basic member is configured to engage with the latch hole.

12. The connector of claim 11, wherein the basic member comprises a linking portion, the linking portion is configured to engage with the latch hole.

13. The connector of claim 12, wherein the linking portion and the latch hole is interference fit.

14. The connector of claim 12, wherein the linking portion is cubic.

15. The connector of claim 12, wherein the basic member further comprises a connecting portion, and a width of the connecting portion is greater than a width of the linking portion.

16. The connector of claim 15, wherein the connecting portion is connected to the linking portion to form a first step surface, and the first step surface is configured to resist a surface of the bottom plate.

17. The connector of claim 10, wherein the latch member comprises a coupling portion and a coupling portion, and a width of the securing portion is greater than a width of the coupling portion.

18. The connector of claim 17, wherein the securing portion is connected to the coupling portion to form a second step surface, and the second step surface is configured to resist a surface of the bottom plate.

19. The connector of claim 10, wherein the basic member comprises a linking portion, and the latch member comprises a coupling portion for coupling to the linking portion.

20. The connector of claim 10, wherein the basic member and the latch member resist two opposite surfaces of the bottom plate.
